(19) United States
(12) Patent Application Publication
(10) Pub. No.: US 2010/0111366 A1
(43) Pub. Date: May 6, 2010

(54) Imaging with depth information

(76) Inventors: John Edley Wilson, North Wales (GB); Matthew Gerard Reed, North Wales (GB); John Benjamin Mitchell, Anglesey (GB); Philip Michael Birch, East Sussex (GB)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/308,970

(22) PCT Filed: Jun. 28, 2007
(86) PCT No.: PCT/GB2007/002424

§ 371 Date: Nov. 2, 2009

(30) Foreign Application Priority Data
Jun. 28, 2006 (GB) 0612786.4

(51) Int. Cl. G06K 9/62

(52) U.S. Cl. 382/106

(57) ABSTRACT

A method and apparatus for depth imaging by triangulation in which a pattern is projected on to an object scene and the scene, and the pattern, imaged, the projection and the imaging being spatially offset, in which the pattern has a characteristic dimension x and depth changes in the object scene cause deformations in the image of the pattern having a maximum dimension Δx, characterised in that Δx<x.

This invention relates to imaging with depth information.

One method for imaging with depth information is triangulation in which a pattern is projected on to an object scene from a position off axis with regard to an imaging device. The pattern is deformed in the image, and the depth is calculated for any image point by the extent of deformation.

In practice, the calculation is made for a discrete number of points spread over the entire image surface. For any reasonable amount of depth information, the number of points is quite large, and the amount of computation is considerable. Carrying out the calculations in real time for video imaging would require considerable, and correspondingly expensive, computing power.

The problem is exacerbated by the fact that larger changes in depth, particularly where there are discontinuities, as, for example, where a hand is extended towards the camera, produce large pattern deformations and confusion where deformed pattern features overlap. Sophisticated measures have to adopted to deal with the ambiguities, such, for instance, as using temporally varying patterns or colour codification.

The present invention achieves video rate imaging with depth information without the problems aforementioned.

The invention comprises a method for depth imaging by triangulation in which a pattern is projected on to an object scene and the scene, and the pattern, imaged, the projection and the imaging being spatially offset, in which the pattern has a characteristic dimension x and depth changes in the object scene cause deformations in the image of the pattern having a maximum dimension Δx, characterised in that Δx<x.

The pattern may be of lines, particularly parallel, evenly spaced, straight lines. The characteristic dimension x may then be the interlinear distance.

The pattern may, however, be of dots, or two-dimensional shapes, which may be ellipses (including circles) or polygons such as triangles or squares, particularly congruent, evenly spaced shapes, when the characteristic dimension x may be the area of the shape.

The pattern may be substantially in focus throughout the object scene.

The pattern may be projected at a wavelength outwith the optical spectrum, for example, in infra red light.

The pattern may be subtracted from the scene/pattern image after depth information has been computed.

The imaging may be effected at video rate.

The invention also comprises apparatus for depth imaging by triangulation, comprising pattern projection means adapted to project a pattern on to an object scene, and imaging means adapted to image the scene and the pattern, the projection means and the imaging means being spatially offset, in which the projected pattern has a characteristic dimension x and depth changes in the object scene cause deformations in the image of the pattern having a maximum dimension Δx, characterised in that Δx<x.

The imaging means may comprise a video camera.

The pattern projection means may project the pattern at a wavelength outwith the optical spectrum, for example in infra-red light.

The pattern projection means may comprise a laser light source, for example an infra-red laser.

The pattern projection means may comprise an optical system comprising a The apparatus may be adapted for imaging a scene up to a distance of 5 m.

The apparatus may be adapted as imaging apparatus for a computer or Eye Toy game.

Methods and apparatus for depth imaging by triangulation according to the invention will now be described with reference to the accompanying drawings, in which:

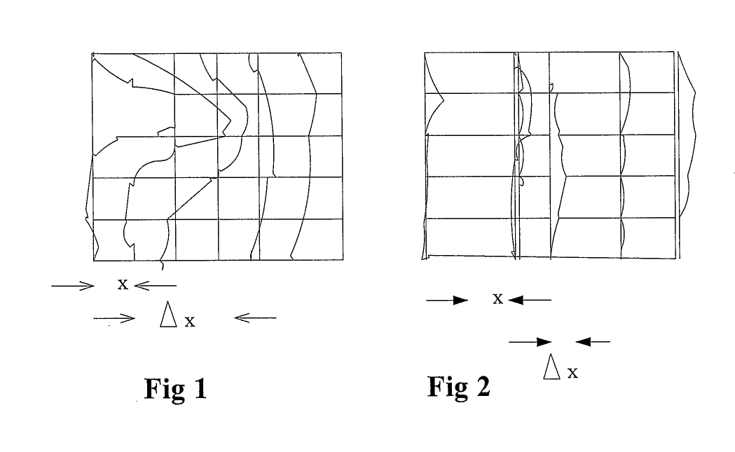

FIG. 1 is an image of a pattern distorted by depth variations in a prior art arrangement;

FIG. 2 is an image like FIG. 1, according to the invention;

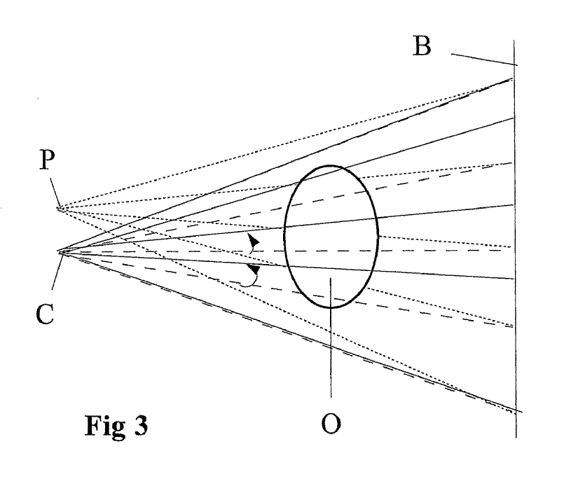

FIG. 3 is a diagrammatic illustration of depth imaging apparatus according to the invention;

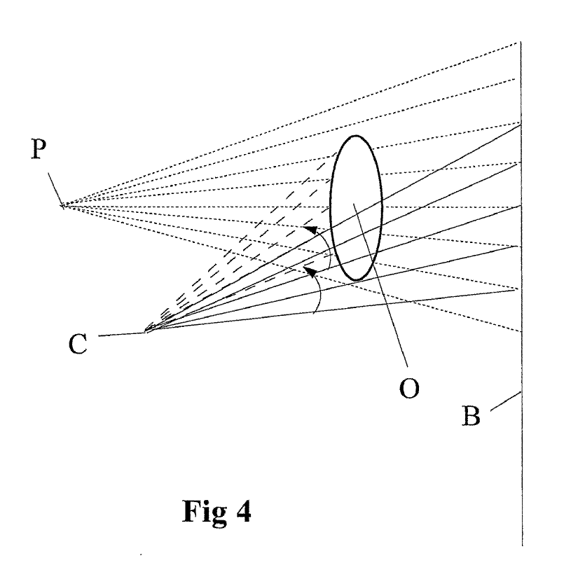

FIG. 4 is a diagrammatic illustration of a prior art depth imaging apparatus;

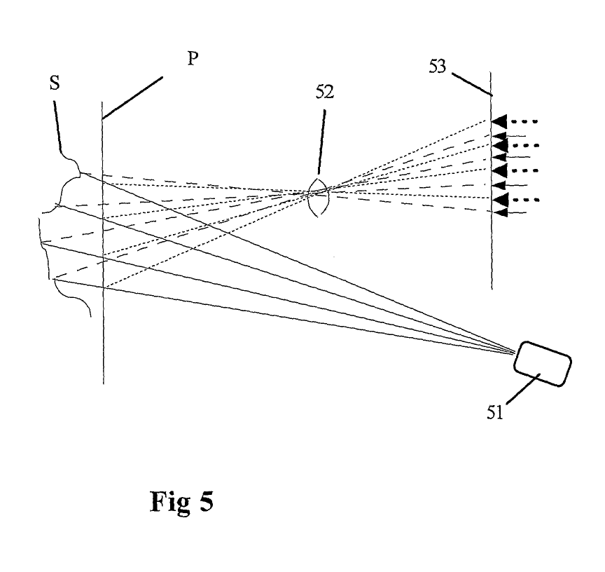

FIG. 5 is a diagrammatic illustration showing how a pattern is displaced on an imaging screen by depth variation in an object scene;

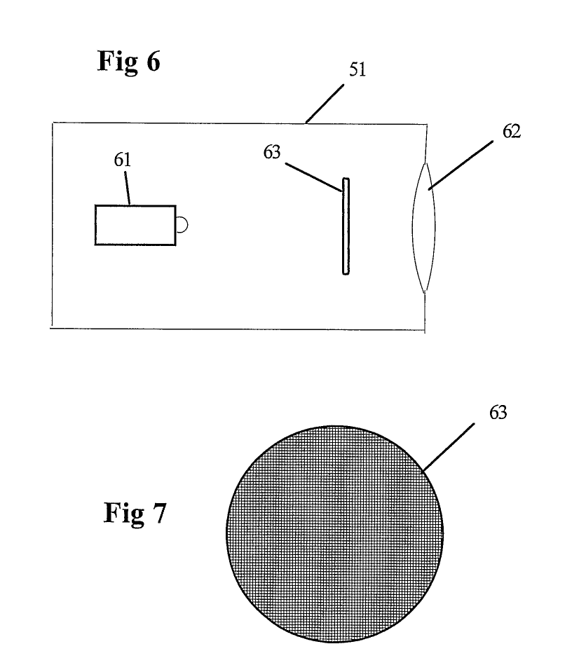

FIG. 6 is a diagrammatic illustration of a projector for depth imaging apparatus according to the invention: and

FIG. 7 is a face-on view of a pattern generator of the apparatus of FIG. 6.

The drawings illustrate a method for depth imaging by triangulation in which a pattern P is projected on to an object scene S and the scene P and the pattern S, imaged, the projection and the imaging being spatially offset, in which the pattern P has a characteristic dimension x and depth changes in the object scene S cause deformations in the image of the pattern having a maximum dimension Δx, characterised in that Δx<x.

As will be seen from FIG. 1 (prior art), deformations 11 of dimension Δx due to depth changes in the object scene are larger than the spacing x of the lines of a pattern of parallel lines cast on to the object scene for measuring depth by triangulation.

This gives rise to confusion inasmuch as it is not clear, from sampling the image in the area A, which of the two lines 12, 13 has been deformed. This gives rise to ambiguous depth information, and special, and computationally expensive, measures must be resorted to in order to resolve the ambiguity.

By arranging, however, that the maximum deformation Δx is less than the line spacing x, as shown in FIG. 2, no ambiguity arises.

FIGS. 3 and 4 show how these different situations arise in practice.

In these Figures, P is the projector, C is the camera and O is the object, being viewed against a background B. Pattern lines projected from P are shown as rays in dotted line. Lines from the camera C to the intercepts of the pattern rays on the object O and background B are solid lines. Dashed lines join the camera to the virtual intercepts of the pattern rays on the background.

Arrows show the angular displacement between the dashed lines and the corresponding solid lines, indicating deformation of the pattern due to the presence of the object O.

It is seen that, in FIG. 3, which show the position according to the invention, the angular displacement (and hence the characteristic dimension at any position) is always less than the angle between adjacent solid lines, the requirement for Δx<x.

This is not the case in FIG. 4, which shows the prior art position. Here, the angular displacement as indicated by the arrows, is sometimes, at least, greater than the angle between adjacent solid lines, leading to ambiguity as to which pattern line is which.

FIG. 5 shows the inventive arrangement in more detail. A projector 51 projects the pattern on to an object scene S. A camera lens 52 casts an image of the scene S on to an imaging surface 53, which might be a camera film or a CCD array. Rays R of the pattern strike the scene S and are imaged by the lens 52 on the surface 53 at the points indicated by the solid line arrows.

P is an imaginary plane in front of the scene S. If there were a plane S onto which the pattern fell, the rays from the projector 51 would be imaged on the plane 53 at positions indicated by the broken line arrows. The distances Δx between corresponding broken line and solid arrows are less than the distances x between solid line arrows.

FIG. 6 shows the projector 51 of FIG. 5. It comprises a light source 61, a projection lens 62 and a pattern screen 63, also shown face-on in FIG. 7.

The light source 61 can be a laser, and the pattern screen 63 can be a diffractive optical element (DOE). Suitable lasers include 10 mW helium gas lasers, 75 mW 660 nM diode laser and 120 mW infra red laser diodes With a monochromatic laser, a matched narrow filter can be placed in front of the camera lens to increase signal-to-noise ration for pattern detection.

The DOE may provide a square array of spots, which may be, for example, a 64×64 array.

Such arrangements are compact, but powerful enough for imaging an object scene of several cubic metres, powered by dry cells and therefore very portable and efficient.

We claim:

1. A method of depth imaging by triangulation in which a pattern is projected on to an object scene and the scene, and the pattern, imaged, the projection and the imaging being spatially offset, in which the pattern has a characteristic dimension x and depth changes in the object scene caused deformations in the image of the pattern having a maximum dimension Δx, characterised in that Δx<x.

2. A method according to claim 1, in which the pattern is of lines.

3. A method according to claim 2, in which the pattern is of parallel, evenly spaced, straight lines, and the characteristic dimension is the interlinear distance.

4. A method according to claim 1, in which the pattern is of dots.

5. A method according to claim 4, in which the characteristic dimension is inter-dot spacing.

6. A method according to claim 1, in which the pattern is of two-dimensional shapes.

7. A method according to claim 6, in which the shapes are ellipses (including circles).

8. A method according to claim 6, in which the shapes are polygons.

9. A method according to claim 8, in which the shapes are triangles.

10. A method according to claim 6, in which the shapes are squares.

11. A method according to claim[s] 6, in which the shapes are congruent, evenly spaced shapes, and the characteristic dimension x is the area of the shape.

12. A method according to claim[s] 1, in which the pattern is substantially in focus throughout the object scene.

13. A method according to claim[s] 1, in which the pattern is projected at a wavelength outwith the optical spectrum.

14. A method according to claim 12, in which the pattern is projected in infra red light.

15. A method according to claim[s] 1, in which the pattern is subtracted from the scene/pattern image after depth information has been computed.

16. A method according to claim[s] 1, in which the imaging is effected at video rate.

17. Apparatus for depth imaging by triangulation comprising pattern projection means adapted to project a pattern on to an object scene and imaging means adapted to image the scene and the pattern projected on to it, the projection means and the imaging means being spatially offset, in which the pattern projection means project a pattern which has a characteristic dimension x, and depth changes in the object scene cause deformations in the image of the pattern having a maximum dimension Δx, characterised in that Δx<x.

18. Apparatus according to claim 17, in which the pattern is of lines.

19. Apparatus according to claim 18, in which the pattern is of parallel, evenly spaced, straight lines, and the characteristic dimension is the interlinear distance.

20. Apparatus according to claim 17, in which the pattern is of dots.

21. Apparatus according to claim 20, in which the characteristic dimension is the inter-dot spacing.

22. Apparatus according to claim 17, in which the pattern is of two-dimensional shapes.

23. Apparatus according to claim 22, in which the shapes are ellipses (including circles).

24. Apparatus according to claim 22, in which the shapes are polygons.

25. Apparatus according to claim 22, in which the shapes are triangles.

26. Apparatus according to claim 22, in which the shapes are squares.

27. Apparatus according to claim[s] 22, in which the shapes are congruent, evenly spaced shapes, and the characteristic dimension x is the area of the shape.

28. Apparatus according to claim[s] 17, in which the pattern is arranged to be substantially in focus throughout the object scene.

29. Apparatus according to claim[s] 17, in which the pattern is projected at a wavelength outwith the optical spectrum.

30. Apparatus according to claim 28, in which the pattern is projected in infra red light.

31. Apparatus according to claim[s] 17 further comprising image processing means adapted to subtract the pattern from the scene/pattern image after depth information has been computed.

32. Apparatus according to claim[s] 31, in which the imaging is effected at video rate.
